(19) United States
(12) Patent Application Publication
(10) Pub. No.: US 2020/0218681 A1
(43) Pub. Date: Jul. 9, 2020

(54) METHOD FOR AUTOMATICALLY IDENTIFYING HOST OPERATING SYSTEMS

(71) Applicant: PROLIFIC TECHNOLOGY INC., Taipei (TW)

(72) Inventors: TIEN-WEI YU, Taipei (TW); CHUN-SHIU CHEN, Taipei (TW)

(21) Appl. No.: 16/825,486

(22) Filed: Mar. 20, 2020

Related U.S. Application Data
(63) Continuation of application No. 15/245,174, filed on Aug. 24, 2016.

(51) Int. Cl. G06F 13/38; G06F 13/42

(52) U.S. Cl. CPC G06F 13/385; G06F 13/4282

(57) ABSTRACT

The present invention provides a method for automatically identifying host operating system. By applying the method of automatically identifying host operating system in a USB control unit of a USB device by a form of application program, library, variables, and/or operands, the USB control unit is therefore provided with a host operating system identifying function. As such, in case of a specific OS of a host device applying a USB enumeration to the forgoing USB device, the central processing unit would automatically identify (or detect) what the specific OS is. For example, the specific OS is identified as an Apple iOS operating system, a Microsoft Windows operating system, an Apple Mac OS operating system, or a Google Android operating system.

### CROSS-REFERENCE TO RELATED APPLICATIONS

This application is a continuation application of U.S. patent application Ser. No. 15/245,174 filed on Aug. 24, 2016 entitled “METHOD AND DEVICE CAPABLE OF AUTOMATICALLY IDENTIFYING HOST OPERATING SYSTEMS”.

### BACKGROUND OF THE INVENTION

### 1. Field of the Invention

The present invention relates to the technology field of USB devices, and more particularly to a method for automatically identifying host operating systems.

### 2. Description of the Prior Art

Through the plug-and-play characteristic of universal serial bus (USB), desk computers or notebooks can easily expand their peripheral devices having an USB interface, such as mouse, keyboard, joystick, scanner, digital camera, printer, flash drive, portable external hard drive, optical drive, wireless network card, speaker, and microphone.

As engineers skilled in USB device designing and manufacturing technology field know, a specific operating system installed in a host electronic device would automatically treat a specific USB device with an USB enumeration procedure when the specific USB device is connected to the host electronic device. Taking Windows XP as the example of the operating system, wherein the USB enumeration procedure executed by Windows XP consists of following steps:
step (1′): initialing the USB device, and then setting a device address of the USB device as 0;
step (2′): requesting the USB device to reply a 64-byte length device descriptor;
step (3′): resetting the USB device, and then sending a “Set Address” command to the USB device so as to complete the address setting of the USB device;
step (4′): requesting the USB device to reply a 18-byte length device descriptor for obtaining foundational information of the USB device, such as VID (vender identification) and PID (product identification);
step (5′): requesting the USB device to reply a 9-byte length configuration descriptorfor getting the number of interfaces of the USB device (bNumInterfaces);
step(6′): requesting the USB device to reply an interface descriptor, so as to know the number of end points of the USB device (bNumEndpoints);
step (7′): requesting the USB device to reply an endpoint descriptor for obtaining the data transmission mode of the endpoints (bmAttributes); and
step (8′): waiting for completing the driving of the USB device by USB device driving software.

Moreover, the engineers skilled in USB device designing and manufacturing technology field also know that, some of commercial USB devices just can support one specific operating system because the steps of USB enumeration procedure adopted by others operating system such as iOS or Android would be not completely identical to the above-listed steps (1′)-(8′). For instance, RNDIS (Remote Network Driver Interface Specification) is a Microsoft proprietary protocol implemented in a first USB network device, wherein the first USB network device merely supports Windows XP and other advanced Windows operating systems. On the other hand, CDC/ECM (Communications Device Class/Ethernet Control Model) is another one proprietary protocol implemented in a second USB network device, wherein the second USB network device merely supports the operating systems of Mac OS and Linux.

With the update and increase of USB interfaces' type, all operating systems including Microsoft's Windows, Apple's Mac OS and iOS, Google's Android, and Linus constantly upgrade their expandability on USB devices; nevertheless, USB devices or interfaces must simultaneously possess outstanding host operating system identifying ability in order to support all of the operating systems. In view of that, inventors of the present application have made great efforts to make inventive research thereon and eventually provided a method for automatically identifying host operating systems.

### SUMMARY OF THE INVENTION

The primary objective of the present invention is to provide a method for automatically identifying host operating system. By applying the method of automatically identifying host operating system in a USB control unit of a USB device by a form of application program, library, variables, and/or operands, the USB control unit is therefore provided with a host operating system identifying function. As such, in case of a specific OS of a host device applying a USB enumeration to the forgoing USB device, the central processing unit would automatically identify (or detect) what the specific OS is. For example, the specific OS is identified as an Apple iOS operating system, a Microsoft Windows operating system, an Apple Mac OS operating system, or a Google Android operating system.

In order to achieve the primary objective of the present invention, the inventor of the present invention provides an embodiment for the method of automatically identifying host operating system, comprising following steps:
(1) connecting a USB device to a host electronic device installed with an operating system;
(2) configuring the USB device to identify the operating system as an Apple iOS operating system or a Microsoft Windows operating system after receiving an address setting command from the operating system;
(3) configuring the USB device to identify the operating system as an Apple Mac OS operating system after the operating system requests the USB device to reply a first device descriptor having a first byte length; and
(4) configuring the USB device to identify the operating system as a Google Android operating system after the operating system requests the USB device to reply a second device descriptor having a second byte length smaller than the first byte length as well as requests the USB device to reply the device descriptor repeatedly.

In one embodiment, the forgoing USB device is an USB bridge interface selected from the group consisting of: USB-I 2C bridge interface, USB-SPI bridge interface, USB-UART bridge interface, USB-eMMC bridge interface, USB-SATA bridge interface, USB-PATA bridge interface, USB-I 2S bridge interface, USB-USB bridge interface, USB-SD bridge interface, and combination thereof.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 shows a stereo diagram of an USB device integrated with USB and wireless network technologies;

FIG. 2 shows a first circuit block diagram of first circuit block diagram of a USB device that is provided with a method of automatically identifying host operating system therein;

FIG. 3 shows a second circuit block diagram of the forgoing USB device;

FIG. 4 shows a flowchart diagram of the method of automatically identifying host operating system according to the present invention.

### DETAILED DESCRIPTION OF THE PREFERRED EMBODIMENTS

To more clearly describe a method for automatically identifying host operating system according to the present invention, embodiments of the present invention will be described in detail with reference to the attached drawings hereinafter.

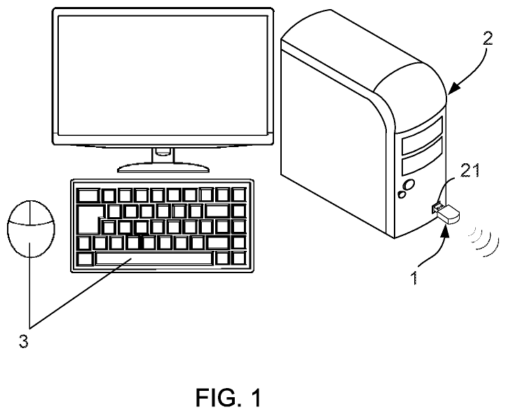

It is well known that USB devices or USB products have been widely used and applied in human life, such as mouse, keyboard, joystick, scanner, digital camera, printer, flash drive, portable external hard drive, optical drive, wireless network card, speaker, and microphone. On the other hand, the usability of USB devices and wireless network technology also lead electronic products integrated with USB and wireless interfaces to be broadly developed and proposed, such as wireless microphone, wireless mouse, and wireless keyboard. Please refer to FIG. 1, which illustrates a stereo diagram of an USB device integrated with USB and wireless interfaces. As FIG. 1 shows, a USB device 1 having network-connecting capability is connected to a host electronic device 2 through a USB interface 21. As such, the USB device 1 establishes a bridge connection between the host electronic device 2 and a wireless mouse and a wireless keyboard (i.e., wireless I/O devices 3), such that the wireless I/O devices 3 therefore become peripheral devices of the host electronic device 2.

The USB device 1 shown in FIG. 1 is a USB-SPI bridge interface, wherein SPI is an abbreviation of serial peripheral interface. Of course, with the development of electronic technologies, USB device 1 is not limited to be the USB-SPI bridge interface, which can also be a USB-I 2C bridge interface, a USB-UART bridge interface, a USB-eMMC bridge interface, a USB-SATA bridge interface, a USB-PATA bridge interface, a USB-I 2S bridge interface, a USB-USB bridge interface, or a USB-SD bridge interface.

The corresponding descriptions for the notations of “I2C”, “UART”, “eMIVIC”. “SATA”. “PATA”. “I2S”. and “SD” are orovided in following Table (1).

TABLE 1

| Notation | Description |
|---|---|
| I2C | Inter-Integrated Circuit |
| UART | Universal Asynchronous Receiver/Transmitter |
| eMMC | Embedded Multi Media Card |
| SATA | Serial Advanced Technology Attachment |
| PATA | Parallel Advanced Technology Attachment |
| I2S | Inter-IC Sound |
| SD | Secure Digital Memory Card |

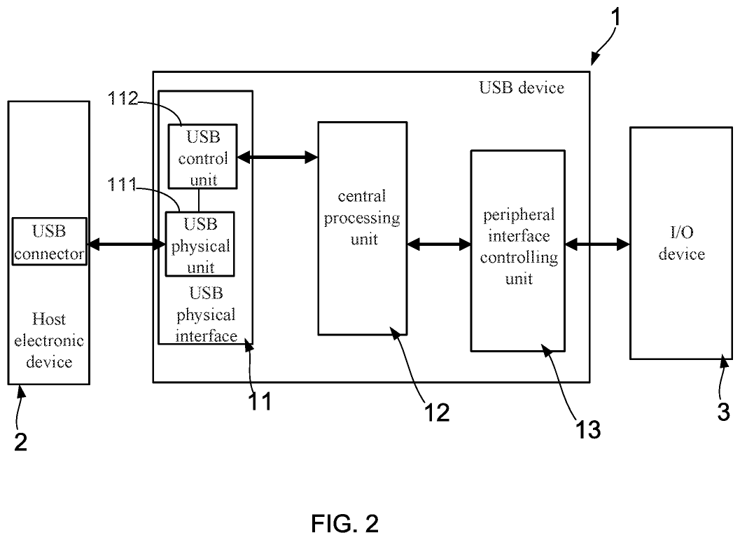

Please refer to FIG. 2, which illustrates a first circuit block diagram of the USB device. As FIG. 2 shows, the USB device 1 comprises: a USB physical interface 11, the central processing unit 12, and at least on peripheral interface controlling unit 13. The USB physical interface 11 is used for being connected to the USB interface 21 of the host electronic device 2, and comprises a USB physical unit 111 and a USB control unit 112. Engineers skilled in development and manufacture of USB devices should know that, the forgoing USB physical unit 111 can be an USB 2.0 connector, an USB 3.0 connector, a mini USB connector, or a micro USB connector.

Particularly, the present invention provides a method for automatically identifying host operating system, and applies the method of automatically identifying host operating system in the USB control unit 112 of the USB device 1 by a form of application program, library, variables, and/or operands, thereby making the central processing unit has a host operating system identifying function.

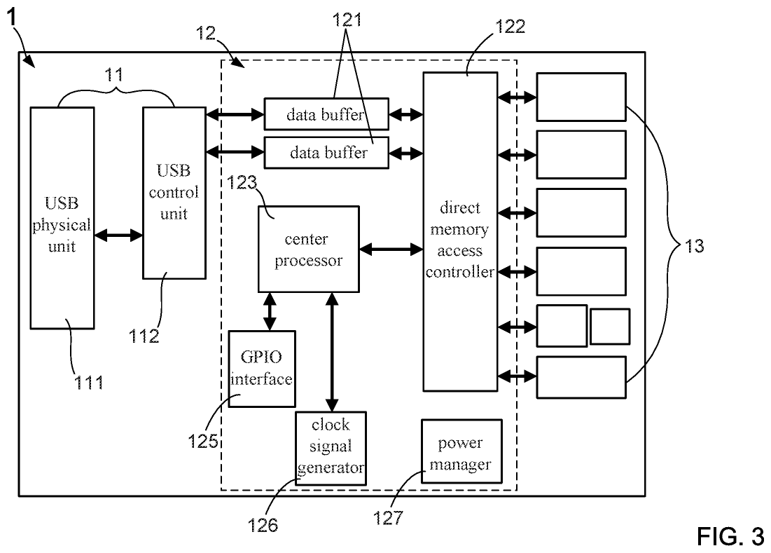

Continuously referring to FIG. 2, and please simultaneously refer to FIG. 3, where a second circuit block diagram of the USB device is provided. From FIG. 2 and FIG. 3, it is understood that, the central processing unit 12 of the USB device 1 comprises: at least one data buffer 121, a direct memory access controller 122, a center processor 123, a GPIO (general purpose I/O) interface 125, a clock signal generator 126, and a power manager 127. In which, the data buffer 121 is coupled to the USB control unit 112, and the direct memory access controller 122 is coupled to the data buffer 121, the peripheral interface controlling unit 13 and the center processor 123.

As described in more detail below, the center processor 123 is also coupled to the GPIO interface 125 and the clock signal generator 126. By such arrangement, the USB control unit 112 immediately transmits data to the data buffer 121 in case of the host electronic device 2 outputting data to the USB physical unit 111 of the USB physical interface 11. Meanwhile, the power manager 17 provides power to the central processor 123 and the direct memory access controller 122 based on a clock signal outputted by the clock signal generator 125, such that the central processor 123 makes the data buffer 121 transmit the data to the peripheral interface controlling unit 13 through the direct memory access controller 122. Eventually, the peripheral interface controlling unit 13 transmits the data (or signal) to at least one wireless I/O device 3 that is wirelessly connected to the USB device 1.

From FIG. 1 and FIG. 2, it is understood that the forgoing I/O device 3 can be a wireless mouse or a wireless keyboard, and the USB device 1 can be a USB dongle device. In such case, the peripheral interface controlling unit 13 of the USB device 1 is a SPI control interface, reasonably. Of course, the USB device 1 may be put into practice by a form of USB-I 2C bridge device, USB-UART bridge device, USB-eMMC bridge device, USB-SATA bridge device, USB-PATA bridge device, USB-I 2S bridge device, USB-USB bridge device, or USB-SD bridge. Therefore, the peripheral interface controlling unit 13 is correspondingly an I2C control interface, a UART control interface, an eMMC control interface, a SATA control interface, a PATA control interface, a I2S control interface, a SD control interface, or a USB control interfac.

The present invention embeds an operating system (OS) identifying library in the USB control unit 112 of the USB physical interface 11. Therefore, when an operating system installed in the host electronic device 2 applies an USB enumeration to the USB device 1, the OS identifying library is enabled to determine what the operating system is.

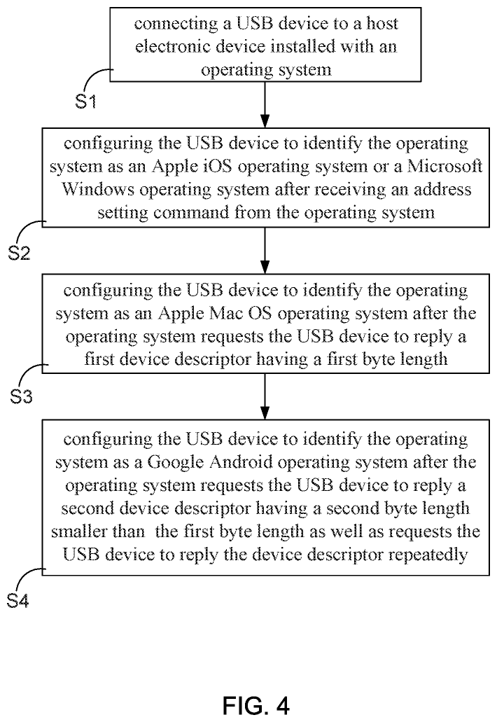

FIG. 4 shows a flowchart diagram of the method for automatically identifying host operating system according to the present invention. The method mainly comprises 4 steps of
S1: connecting a USB device to a host electronic device installed with an operating system;
S2: configuring the USB device to identify the operating system as an Apple iOS operating system or a Microsoft Windows operating system after receiving an address setting command from the operating system;
S3: configuring the USB device to identify the operating system as an Apple Mac OS operating system after the operating system requests the USB device to reply a first device descriptor having a first byte length; and
S4: configuring the USB device to identify the operating system as a Google Android operating system after the operating system requests the USB device to reply a second device descriptor having a second byte length smaller than the first byte length as well as requests the USB device to reply the device descriptor repeatedly.

In following paragraphs, the way to achieve the method of automatically identifying host operating system will be detailedly explained. Engineers skilled in development and manufacture should know that, after a USB device 1 is connected to a host electronic device 2, the operating system of the host electronic device 2 would apply an USB enumeration to the USB device 1. Meanwhile, the USB device 1 is configured, by the OS identifying library that is provided in the USB control unit 112, to identify the operating system as an Apple iOS operating system or a Microsoft Windows operating system after receiving an address setting command from the operating system.

In step S2, it is further determined whether the operating system requests the USB device 1 to reply a configuration descriptor having a specific byte length smaller than 9 bytes, if yes, the operating system is eventually identified as the Apple iOS operating system. If no, however, the operating system is eventually identified as the Microsoft Windows operating system.

In step S3, the USB device 1 is configured to identify the operating system as an Apple Mac OS operating system after the operating system requests the USB device to reply a first device descriptor having a first byte length (18-byte length). In step S4, the USB device 1 is configured to identify the operating system as a Google Android operating system after the operating system requests the USB device to reply a second device descriptor having a second byte length smaller than the first byte length as well as requests the USB device to reply the device descriptor repeatedly.

Moreover, by using following steps, the method of the present invention is able to recognize the version of the forgoing Microsoft Windows operating system.
step (S81): determining whether the operating system requests the USB device to reply a configuration descriptor having a specific byte length greater than 9 bytes, if yes proceeding to step (S82); otherwise, proceeding to step (S83);
step (S82): identifying the operating system as the Microsoft Windows Vista operating system, Microsoft Windows 7 operating system, or Microsoft Windows 8 operating system, and then proceeding to the ending step; step (S83): identifying the operating system as the Microsoft Windows XP operating system, and then proceeding to the ending step.

Therefore, through above descriptions, the method of automatically identifying host operating system provided by the present invention has been introduced completely and clearly. The above description is made on embodiments of the present invention. However, the embodiments are not intended to limit scope of the present invention, and all equivalent implementations or alterations within the spirit of the present invention still fall within the scope of the present invention.

What is claimed is:

1. A method for automatically identifying host operating system, comprising following steps:
(1) connecting a USB device to a host electronic device installed with an operating system;
(2) configuring the USB device to identify the operating system as an Apple iOS operating system or a Microsoft Windows operating system after receiving an address setting command from the operating system;
(3) configuring the USB device to identify the operating system as an Apple Mac OS operating system after the operating system requests the USB device to reply a first device descriptor having a first byte length; and
(4) configuring the USB device to identify the operating system as a Google Android operating system after the operating system requests the USB device to reply a second device descriptor having a second byte length smaller than the first byte length as well as requests the USB device to reply the device descriptor repeatedly.

2. The method of claim 1, wherein the USB device is selected from the group consisting of: mouse, keyboard, joystick, scanner, digital camera, printer, flash drive, portable external hard drive, optical drive, wireless network card, speaker, and microphone.

3. The method of claim 1, method of claim 1, wherein the USB device is an USB bridge interface selected from the group consisting of: USB-I 2C bridge interface, USB-SPI bridge interface, USB-UART bridge interface, USB-eMMC bridge interface, USB-SATA bridge interface, USB-PATA bridge interface, USB-I 2S bridge interface, USB-USB bridge interface, and USB-SD bridge interface.
